(19) United States
(12) Patent Application Publication
(10) Pub. No.: US 2019/0177516 A1
(43) Pub. Date: Jun. 13, 2019

(54) Composite Materials of Tire Sidewall Rubber and Preparation Method thereof

(71) Applicant: Shandong Linglong Tire Co., Ltd., ZHAOYUAN (CN)

(72) Inventors: FENG WANG, ZHAOYUAN (CN); CHENJING WU, ZHAOYUAN (CN); YONG MA, ZHAOYUAN (CN); QIUHAI NIE, ZHAOYUAN (CN); YANJUN LIN, ZHAOYUAN (CN); LI LIU, ZHAOYUAN (CN)

(73) Assignee: Shandong Linglong Tire Co., Ltd.

(21) Appl. No.: 16/214,776

(22) Filed: Dec. 10, 2018

(30) Foreign Application Priority Data
Dec. 11, 2017 (CN) 201711308789.7

(51) Int. Cl. C08L 9/06; C08L 7/00; C08L 71/12; C08K 3/04; C08K 3/06; C08K 3/22; C08K 5/09; C08K 5/18; C08K 5/39; C08K 5/44; C08K 5/5419; C08K 5/3437; C08J 3/18; B60C 1/00

(52) U.S. Cl. CPC C08L 9/06; C08K 2003/2227; C08L 71/12; C08K 3/04; C08K 3/06; C08K 3/22; C08K 5/09; C08K 5/18; C08K 5/39; C08K 5/44; C08K 5/5419; C08K 5/3437; C08J 3/18; B60C 1/0025; C08K 2003/2296; C08K 2003/2217; C08L 7/00

(57) ABSTRACT

The present invention relates to composite materials for tire, specifically to composite materials of tire sidewall rubber. A preparation method of the composite materials comprises the following steps of: plasticating rubber in an internal mixer, adding other component except for the sulfur powder and the accelerator to blend, lifting ram piston at 120˜125° C., discharging rubber at 150˜160° C. to obtain rubber compound, then mixing the rubber compound with the sulfur powder and the accelerator in open mill, rolling for 4˜5 times and milling for 5˜8 times to obtain product. The composite materials of the present invention not only meet the requirements of basic mechanical properties of the sidewall rubber, but also obviously improve thermo-oxidative aging resistance and ultraviolet aging resistance of the sidewall rubber, and thereby effectively prolong the service life of the tire.

### CROSS-REFERENCE TO RELATED APPLICATIONS

This application claims priority to Chinese Patent Application No. 201711308789.7 with a filing date of Dec. 11, 2017. The content of the aforementioned application, including any intervening amendments thereto, are incorporated herein by reference.

### FIELD OF THE INVENTION

The present invention relates to composite materials for tire, specifically to composite materials of tire sidewall rubber and preparation method thereof.

### BACKGROUND OF THE INVENTION

The sidewall of tire is located in the outside surface of the tire, and located between tire tread and tire bead. The sidewall surface easily occurs cracking and aging by prolonged exposure to external environment and long suffering from erosion of light, heat, oxygen and ozone over time. The compound design of radial tire sidewall rubber should focus on ensuring that the radial tire sidewall rubber has good resistance capacity of anti-thermal oxidative aging, ozone aging and ultraviolet aging. In the prior art, the effective method of solving the cracking of sidewall surface is usually to add antiager to rubber material, prevent reaction of ozone and unsaturated polymer of sidewall rubber based on the principle that the antiager continuously migrating from internal rubber material to the surface of sidewall can react with ozone. In a certain amount range, the more the antiager is added, the better anti-oxidation cracking performance the rubber material has. But the more the antiager is used, the more the antiager migrates to the sidewall surface. Because most of the antiager is reddish brown or dark brown, and at the same time, the oxidation reaction product of the antiager on the sidewall surface is also reddish brown, the sidewall surface is reddish brown, which affect the appearance and quality of the tire.

With the developments of science and technology, the requirements for the quality of the tire is getting higher and higher, and the aging resistance of the sidewall rubber has been paid more and more attention. If you need to further improve the aging resistance of the radial tire sidewall rubber, you can not blindly increase the amount of the antiager. There is a need to search for a tire sidewall rubber with excellent overall performance and good aging resistance.

Hydrotalcite is multiple superposition layer structure formed by inorganic laminate of double metal hydroxide and interlayer carbonate. Its inorganic laminate can play a role in physical shielding to ultraviolet ray. The metallic elements on the laminate and layer anion can play a role in chemical absorption of ultraviolet ray. At the same time, when ultraviolet ray passes through the multiple laminate, multiple reflections and refraction occur at the interface of the laminate, which plays a role in shielding to ultraviolet ray. Meanwhile, there are no cracks in the layer of the hydrotalcite. The regularity of crystal is high and there are few edge defect. The hydrotalcite has a good effect on gas barrier, and can play a certain physical protective effect on ozone and thermal oxygen aging. At the same time, organic modification technology of the hydrotalcite can increase the lipophilicity of the hydrotalcite to a certain extent, and increase its compatibility with the rubber. Therefore, the method of combining hydrotalcite with conventional antiagers can be used to further improve the aging resistance of the sidewall rubber composite materials.

### SUMMARY OF THE INVENTION

The technical problem to be solved by this invention lies in that if the antiager is only used to improve cracking and aging of sidewall surface, with the increase of the antiager, the antiager migrating to the sidewall surface could easily make the sidewall surface with colour, which affects the appearance and quality of the tire.

The purpose of the present invention is to provide a composite material of sidewall rubber with good thermo-oxidative aging resistance and ultraviolet aging resistance capacity by adding the hydrotalcite and using the method of conventional antiagers, while without excessively adding an antiager, and at the same time, assures the sidewall rubber with the requirements of basic mechanical properties and appearance quality.

To be specific, the present invention provides the following technical solutions:

The present invention provides a composite materials of tire sidewall rubber, wherein, the composite materials comprise 100 parts by weight of rubber, the materials further comprise 1˜10 parts by weight of hydrotalcite, 40˜70 parts by weight of carbon black, 4.0˜8.0 parts by weight of treated distillate aromatic extract, 3.0˜9.0 parts by weight of antiager, 1.0˜4.0 parts by weight of wax, 0.5˜3.0 parts by weight of tackifying resin, 1.5˜5.0 parts by weight of zinc oxide, 1.0˜3.5 parts by weight of stearic acid, 1.0˜3.0 parts by weight of sulfur powder, and 0.5˜2.0 parts by weight of accelerator.

Preferably, for the above-mentioned composite materials, wherein, the weight ratio of the hydrotalcite to the antiager in the composite materials is 0.25˜2.5, preferably 0.75˜1.75.

Preferably, for the above-mentioned composite materials, wherein, the antiager is one or two or more selected from the group consisting of N-(1,3-dimethylbutyl)-N′-phenyl-p-phenylenediamine,2,2,4-trimethyl-1,2-dihydro quinoline polymer, N,N′-xylyl-p-phenylenediamine,2-mercaptobenzimidazol zinc salt,9,9-dimethylacridan, N,N′-phenyl-p-phenylenediamine and 6-ethoxyl-2,2,4-trimethyl-1,2-dihydrquinoline.

Preferably, for the above-mentioned composite materials, wherein, the rubber is one or two or more selected from the group consisting of natural rubber, butadiene rubber, butyronitrile rubber, styrene-butadiene rubber, isoprene rubber or ethylene-propylene rubber, the wax is one or more selected from the group consisting of micro-crystalline wax, polyethene wax, polypropylene wax or oxidized polyethlene wax.

Preferably, for the above-mentioned composite materials, wherein, the rubber comprises the natural rubber and the butadiene rubber, wherein, the natural rubber accounts for 30˜65 parts by weight, preferably 40˜60 parts by weight; the butadiene rubber accounts for 35˜70 parts by weight, preferably 40˜60 parts by weight.

Preferably, for the above-mentioned composite materials, wherein, the hydrotalcite is one or two or more selected from the group consisting of magnesium aluminum base hydrotalcite, magnesium zinc aluminum hydrotalcite and organo-modified hydrotalcite, wherein, organic modifier of the hydrotalcite is preferably organic silane coupling agent types, the molecular structure characteristic of the organic silane coupling agent is one or two or more organic group selected from the group consisting of —S—S—, —Sx-, —S—H or —C═C—.

Preferably, for the above-mentioned composite materials, wherein, the organic silane coupling agent is one or two or more selected from the group consisting of coupling agent A-151, A-171, A-172, KH540, KH-550, KH-560, KH-570, KH-590, KH-792, Si-602, Si-69 or Si75.

Preferably, for the above-mentioned composite materials, wherein, the layer size of the hydrotalcite is 0.5˜1 μm, preferably the hydrotalcite structure is 30˜50 layers.

Preferably, for the above-mentioned composite materials, wherein, the tackifying resin comprises phenolic resin, the accelerator is one or more selected from the group consisting of N-tert-butyl-2-benzothiazolesulfenamide, zinc dibutyl dithiocarbamate or dipentamethylene thiuram hexasulfide, the carbon black comprises N series of carbon black, and the sulfur powder comprises oil extended sulfur powder.

Preferably, for the above-mentioned composite materials, wherein, the specific surface area of the carbon black is 30˜150 m²/g, preferably 40˜100 m²/g.

The present invention provides a preparation method of the above composite materials, comprising the following steps of:

(1) plasticating rubber in an internal mixer;

(2) adding the hydrotalcite, the carbon black, the treated distillate aromatic extract, the zinc oxide, the stearic acid, the tackifying resin, the antiager and the wax to early out mixing;

(3) lifting ram piston when the temperature of the internal mixer is up to 120˜125° C., then depressing the ram piston;

(4) discharging rubber when the temperature of the internal mixer is up to 150˜160° C. to obtain rubber mix compound;

(5) cooling the rubber mix compound obtained by step (4), placing the rubber compound into open mill, then adding the sulfur powder and the accelerator,mixing and rolling; and

(6) milling to obtain composite materials of tire sidewall rubber.

Preferably, for the above-mentioned preparation method, wherein, the time of plasticating rubber in the internal mixer of step (1) is 20˜50 seconds, the speed of the internal mixer is 80˜100 rpm.

Preferably, for the above-mentioned preparation method, wherein, the time of lifting ram piston of step (3) is 5-10 seconds.

Preferably, for the above-mentioned preparation method, wherein, the rolling time of step (5) is 4˜5 times.

Preferably, for the above-mentioned preparation method, wherein, the milling time of step (6) is 5˜8 times.

The technical effects of the present invention are that:

Compared with the prior art, the effects and benefits of the present invention are that: the composite materials of tire sidewall rubber obtained by adding hydrotalcite and antiager simultaneously, have good thermo-oxidative aging resistance and ultraviolet aging resistance, and at the same time meet the requirements of basic mechanical properties and appearance quality of sidewall rubber.

### DESCRIPTION OF THE PREFERRED EMBODIMENTS

The term “rubber” as used herein, refers to high elastic polymer materials with plastic and deformation, and is rich in elasticity at room temperature. The rubber can generate greater deformation under small external force, and can return to the original state after removing the external force. The rubber belongs to completely amorphous polymer, its glass transition temperature (Tg) is low. A molecular weight of the rubber is often very large, which is more than several hundred thousand.

The term “natural rubber” as used herein, is a natural polymer compound with cis-1,4-polyisoprene as its main component. 91%˜95% of the component is rubber hydrocarbon(cis-1,4-polyisoprene), the others are non-rubber materials such as protein, fat acid, ash content, carbohydrate and the like.

The term “ethylene propylene rubber”as used herein, is a synthetic rubber with ethylene and propylene as the main monomers. According to the difference in monomer composition of molecular chain, the ethylene propylene rubber is classified into binary ethylene propylene rubber and ethylene propylene diene Monomer. The former is a copolymer of ethylene and propylene, denoted as EPM. The latter is a copolymer of ethylene, propylene and a small amount of non-conjugated diene (third monomer), denoted as EPDM. They are collectively known as ethylene propylene rubber, ie. ethylene propylene rubber (EPR). The ethylene propylene rubber can be widely used in automobile parts, waterproof material for building, wire and cable sheath, heat-resistant hoses, tapes, automobile strip, lubricant additives and other products.

The term “wax” as used herein, is oiliness which is produced by animal, plant or minerals. The wax is solid at room temperature, possesses plastic, and is easy to melt. The wax is insoluble in water, but can soluble in carbon disulfide and benzene.

The term “microcrystalline wax” as used herein, is a white unformed amorphous solid wax, which mainly contains C31-70 branched chain saturated hydrocarbon with small amount of cycle and straight chain hydrocarbon. It is odorless and tasteless. The microcrystalline wax is insoluble in ethanol, slightly soluble in hot ethanol, and soluble in benzene, chloroform, ethyl ether and so on.

The term “polyethylene wax” as used herein, also known as high-molecular wax, is widely used due to its excellent cold resistance, heat resistance, chemical resistance and abrasion resistance. The polyethylene wax has good compatibility with polyethylene, polypropylene, polyvinyl acetate, ethylene propylene rubber and butyl rubber. The polyethylene wax can improve the fluidity of polyethylene, polypropylene and ABS and demould properties of polymethyl methacrylate and polycarbonate. Compared with PVC and other external lubricants, the polyethylene wax has a stronger internal lubrication action.

The term “polypropylene wax” as used herein, is a polypropylene wax with low molecular weight. It has characteristics of high melt point, low fusibility, good lubricity and good dispersion and it is an excellent additive for current polyolefin processing. The polypropylene wax has advantages of high practicability, wide application and the like.

The term “oxidized polyethlene wax” as used herein, refers to low molecular weight ethylene-vinyl acetate copolymers containing carbonyl., and is powder with white and slightly yellowish. The oxidized polyethlene wax has good chemical stability and is soluble in aromatic hydrocarbon.

The term “Mg/Al base hydrotalcite” as used herein, refers to the formula of Mg₄Al₂(OH)₁₂CO₃.mH₂O, wherein, MgO (w/%):32.0-34.0, Al₂O₃ (w/%):19.9-21.9, specific surface area (m²/g):≥10.

The term “Mg/Al/Zn base hydrotalcite” as used herein, also known as Mg/Al/Znternary hydrotalcite, refers to the formula of Mg₃ZnAl₂(OH)₁₂CO₃.mH₂O, wherein, MgO (w/%):21.9-23.9, Al₂O₃ (w/%):18.3-20.3, ZnO (w/%):14.4-16.4, specific surface area(m²/g):≥10.

The term “organically modified hydrotalcite” as used herein, refers to organic modified hydrotalcite obtained by using organic modifiers to modify the hydrotalcite. And in present invention, the organic modified hydrotalcite is the organic modified hydrotalcite obtained by using organic silane coupling agent to modify the Mg/Al base hydrotalcite or the Mg/Al/Zn base hydrotalcite.

The term “organic silane coupling agent” as used herein, is a kind of organosilicon compound with a molecular containing two different chemical groups. Its classical product is indicated by the general formula YSiX₃. Wherein, Y is non-hydrolytic groups containing alkenyl (mainly vinyl), and hydrocarbonyl with functional groups of Cl, NH₂, SH, epoxy, N₃, (methyl)acryloyloxy, isocyanate group and so on bearing at the end, ie. carbon functional. X is hydrolyzable groups and contains Cl,OMe, OEt, OC₂H₄OCH₃, OSiMe₃, OAc and the like.

The term “tackifying resin” as used herein, is a small molecule compound which can improve the viscosity of rubber materials, especially the surface. The formula weight of these small molecule compounds is usually between several hundred and ten thousand. And these small molecule compounds have higher glass transition temperature.

The term “dipentamethylenethiuram hexasulfide” as used herein, is accelerator DPPT, and its formula is C₁₂H₂₀N₂S₈. The dipentamethylenethiuram hexasulfide can be used as accelerator of natural rubber, ethylene-propylene rubber, neoprene, styrene-butadiene rubber, butyl rubber, butyronitrile rubber, isoprene rubber, and chlorosulfonated polyethylene rubber.

The term “N-series carbon black” is rubber carbon black, and it mainly plays a reinforcing role in rubber. Generally, the amount of the carbon black used in rubber is between 20% and 70% of the raw rubber. The amount differs depending upon the different rubber products.

The term “oil-filled sulfur powder” as used herein, refers to the sulfur having an oil content of 0.8 to 1.2%.

The composite materials of tire sidewall rubber of the invention have simultaneously added the hydrotalcite and the accelerator. Wherein, the hydrotalcite is layered double hydroxides and intercalation function material with layer structure, which develops fast recent years. It's a layered compound having a supramolecular structure consisting of a positively charged, brucite-like layer and an interlayer portion comprising charge-compensated anions and solvent molecules. Its unique layered structure results in a certain degree of controllability in the composition of its laminae, as well as anion and grain size between layers, and is widely used in barrier material, antibacterial material, catalytic material, anion exchanger and so on. By adjusting and controlling the crystal shape and crystallite size of the hydrotalcite and adjusting the layer ions of the hydrotalcite and the method of introducing organic ultraviolet absorbers between layers and so on, the blocking effect of hydrotalcite on ultraviolet light can be increased. Meanwhile, there is no crack in the layer of hydrotalcite. The crystal of hydrotalcite has higher regularity and less edge defects. The hydrotalcite has better effect on gas barrier, which plays a certain physical protection role in ozone and thermal oxidative aging. Therefore, the composite materials of tire sidewall rubber of the invention have good thermo-oxidative aging resistance and ultraviolet aging resistance.

In an embodiment of the present invention, the composite materials of tire sidewall rubber of the present invention comprise 100 parts by weight of rubber, and according to the amount of rubber, the materials further comprise 1˜10 parts by weight of hydrotalcite, 40˜70 parts by weight of carbon black, 4.0˜8.0 parts by weight of treated distillate aromatic extract, 3.0˜9.0 parts by weight of antiager, 1.0˜4.0 parts by weight of wax, 0.5˜3.0 parts by weight of tackifying resin, 1.5˜5.0 parts by weight of zinc oxide, 1.0˜3.5 parts by weight of stearic acid, 1.0˜3.0 parts by weight of sulfur powder, and 0.5˜2.0 parts by weight of accelerator.

Wherein, with regard to the composite materials of tire sidewall rubber, before aging, shore A hardness is 51˜54, tensile strength is 17.1˜19.2 MPa, elongation at break is 712˜740%, tear strength is 66˜74 KN/m and 25% of resilience is 51˜57%. After aging, shore A hardness is 57˜60, tensile strength is 15˜17.2 MPa, elongation at break is 503˜551%, tear strength is 38˜44 KN/m and 25% of resilience is 54˜58%. With regard to the rate of aging change, the change rate of shore A hardness is 11.1˜11.8%, the change rate of tensile strength is 3.4˜15.%, the change rate of elongation at break is 24.2˜32.0%, the change rate of tear strength is 34.8˜42.5% and the change rate of 25% of resilience is 1.8˜5.9%.

Wherein, with regard to the composite materials of tire sidewall rubber, aging coefficient of tensile product of the composite materials is 0.596˜0.712.

In a prefer embodiment of the present invention, the composite materials of tire sidewall rubber of the present invention comprise 100 parts by weight of rubber, and according to the amount of rubber, the materials further comprise 1˜10 parts by weight of hydrotalcite, 40˜70 parts by weight of carbon black N330, 4.0˜8.0 parts by weight of the treated distillate aromatic extract, 2.0˜5.0 parts by weight of antiager (6PPD), 1.0˜4.0 parts by weight of antiager (RD), 1.0˜4.0 parts by weight of microcrystalline wax, 0.5˜3.0 parts by weight of tackifying resin (0411), 1.5˜5.0 parts by weight of zinc oxide, 1.0˜3.5 parts by weight of stearic acid, 1.0˜3.0 parts by weight of oil-filled sulfur powder, and 0.5˜2.0 parts by weight of accelerator (TBBS). Wherein, the rubber comprises 30˜65 parts by weight of natural rubber and 35˜70 parts by weight of butadiene rubber.

In an embodiment of the present invention, the present invention provides a preparation method of the composite materials of tire sidewall rubber, comprising the following steps of: plasticating rubber in an internal mixer for 20-50 seconds, then adding the hydrotalcite, the carbon black, the treated distillate aromatic extract, the zinc oxide, the stearic acid, the tackifying resin, the antiager 6PPD, the antiager RD and the wax in order to carry out mixing; lifting ram piston once when the temperature of the internal mixer is up to 120˜125° C., discharging rubber when the temperature of the internal mixer is up to 150˜160° C. to obtain rubber mix compound, cooling the rubber mix compound to the room temperature for 8 hours, placing the rubber compound into open mill, then adding the sulfur powder and the accelerator, mixing, after mixing, rolling for 4˜5 times, and milling for 5˜8 times to obtain composite materials of tire sidewall rubber.

In a prefer embodiment of the present invention, the present invention provides a preparation method of the composite materials of tire sidewall rubber, comprising the following steps of: plasticating rubber in an internal mixer for 40 seconds, then adding the hydrotalcite, the carbon black, the treated distillate aromatic extract, zinc oxide, the stearic acid, the tackifying resin, the antiager 6PPD, the antiager RD and the wax in order to carry out mixing, lifting ram piston once when the temperature of the internal mixer is up to 125° C., discharging rubber when the temperature of the internal mixer is up to 155° C. to obtain rubber mix compound, cooling the rubber mix compound to the room temperature for 8 hours, placing the rubber mix compound into open mill, then adding the sulfur powder and the accelerator, mixing, after mixing, rolling for 5 times, and milling for 5 times to obtain composite materials of tire sidewall rubber.

The present invention will be described in further detail with reference to specific examples. The specifications, models and manufacturers of the main reagents and instruments used in the examples are shown in Tables 1 and 2.

TABLE 1
the specifications and manufacturers of the reagents

| reagent | specification | manufacturer |
|---|---|---|
| Natural rubber | SMR 20# | Sinochem International |
| butadiene rubber | BR9000 | Yanshan Petrochemical |
| hydrotalcite | Dry powder | Beijing Techlayer Co., Ltd. |
| | (0.5-1 μm, | |
| | thickness | |
| | of single layer is | |
| | about 0.48 nm; | |
| | 30~50 layers) | |
| Carbon black | N330 | Cabot |
| | (10~100 m²/g) | |
| treated distillate | V500 | Hansen&Rosenthal |
| aromatic extract | | |
| TDAE | | |
| antiager | 6PPD | Jiangsu Sermics Co., Ltd. |
| antiager | RD | SINOPEC Nanjing Chemical |
| | | Industries Co., Ltd. |
| Microcrystalline | 654 | Germany Rhein Chemie Co., Ltd. |
| wax | | |
| tackifying resin | 0411 | Tongyue Chemical Co., Ltd. |
| (phenolic resin) | | |
| Zinc oxide | — | Qingdao HaiyanChemical Co., Ltd. |
| Stearic acid | — | Jiangsu Shuangma Chemical |
| | | Group |
| Sulfur powder | Oil-filled sulfur | Shandong Linyi Hubin Chemical |
| | powder | Co., Ltd. |
| accelerator | TBBS | Yanggu Huatai Chemical Co., Ltd. |

TABLE 2
the models and manufacturers of the instruments

| instrument | model | manufacturer |
|---|---|---|
| Smart laboratory | X(S)M-1.5*(0-120) | Qingdao Kegao Rubber &Plastic |
| rubber-internal | | Technology Equipment Co., Ltd |
| mixer | | |
| Open mill | ROLL-160L | Pan Stone Hydraulic (Anhui) |
| | | Indus. Co., Ltd |
| plate vulcanizing | P-100-2-PCD-2L | Pan Stone Hydraulic (Anhui) |
| machine | | Indus.Co., Ltd. |
| electronic tensile | CMT-4503 | SANS |
| tester | | |
| ultraviolet tube | BFDUV1k | Bofeida Technology Co., Ltd. |

Wherein, the antiager 6PPD is N-(1,3-dimethylbutyl)-N′-phenyl-p-phenylenediamine, and its appearance is dark purple granularity. The crystallization point≥46.0° C., the melting point≥45.0° C. and the relative density is 0.99g/cm³.

The antiager RD is also known as antioxidant. RD and antiager 224. The formula is C₁₂H₁₇N, and the molecular weight is 175.2701. The density is 1.08 g/cm³, the melting point is 72-94° C., the boiling point >315° C., and the water solubility<0.1 g/100 mL at 23° C.

The drop melting point of microcrystalline wax 654 is 65° C., the oil content is 3% (wt %), the chromaticity number is 1, and the penetration ( 1/10 mm) is 2 mm.

tackifying resin (phenolic resin) 411 refers to para-4-tert-butyl phenol formaldehyde resin 0411.

### Example 1

According to the ratio of each ingredient in table 3, the rotational speed of internal mixer was set to 80 rpm, and the initial temperature of the internal mixer was 60° C. The natural rubber and the butadiene rubber were plasticated in an internal mixer for 40 seconds, then organically modified Mg—Al hydrotalcite powder (1 parts by weight), the carbon black N330, treated distillate aromatic extract (TDAE), zinc oxide, stearic acid, para-4-tert-butyl phenol formaldehyde resin 0411, antiager 6PPD, antiager RD and microcrystalline wax were added to the internal mixer to mix. When the temperature of the internal mixer was up to 125° C., lift a ram piston for 10 seconds, and then press the ram piston. When the temperature of the internal mixer was 155° C., the rubber was discharged to obtain a section of rubber mix compound. After the section of rubber mix compound being cooled at room temperature for 8 hours, the sulfur powder and the accelerator TBBS were added to twin-roll open mill to mix until all components dispersed into the rubber. The rubber mix compound was rolled for 5 times, then the roll spacing was set to 2 mm, and the rubber mix compound was milled for 5 times to obtain final mix compound of sidewall rubber with hydrotalcite added, ie. the composite materials of tire sidewall rubber.

### Example 2

Accordirig to the ratio of each ingredient in table 3, the rotational speed of internal mixer was set to 100 rpm, and the initial temperature of the internal mixer was 60° C. The natural rubber and the butadiene rubber were plasticated in an internal mixer for 20 seconds, then organically modified Mg—Al hydrotalcite powder (3 parts by weight), the carbon black N330,the treated distillate aromatic extract (TDAE), zinc oxide, stearic acid, para-4-tert-butyl phenol formaldehyde resin 0411, antiager 6PPD, antiager RD and microcrystalline wax were added to the internal mixer to mix. when the temperature of the internal mixer was up to 120° C., lift a ram piston for 5 seconds, and then press the ram piston. When the temperature of the internal mixer was 160° C., the rubber was discharged to obtain a section of rubber mix compound. After the section of rubber mix compound being cooled at room temperature for 8 hours, the sulfur powder and the accelerator TBBS were added to twin-roll open mill to mix until all components dispersed into the rubber. The rubber mix compound was rolled for 4 times, then the roll spacing was set to 2 mm, and the rubber mix compound was milled for 8 times to obtain final mix compound of sidewall rubber with hydrotalcite added, ie. the composite materials of tire sidewall rubber.

### Example 3

According to the ratio of each ingredient in table 3, the rotational speed of internal mixer was set to 90 rpm, and the initial temperature of the internal mixer was 60° C. The natural rubber and the butadiene rubber were plasticated in an internal mixer for 50 seconds, then organically modified Mg—Al hydrotalcite powder (5 parts by weight), the carbon black N330, the treated distillate aromatic extract (TDAE), zinc oxide, stearic acid, para-4-tert-butyl phenol formaldehyde resin 0411, antiager 6PPD, antiager RD and microcrystalline wax were added to the internal mixer to mix. When the temperature of the internal mixer was up to 120° C., lift a ram piston for 8 seconds, and then press the ram piston. When the temperature of the internal mixer was 150° C., the rubber was discharged to obtain a section of rubber mix compound. After the section of rubber mix compound being cooled at room temperature for 8 hours, the sulfur powder and the accelerator TBBS were added to twin-roll open mill to mix until all components dispersed into the rubber. The rubber mix compound was rolled for 5 times, then the roll spacing was set to 2 mm, and the rubber mix compound was milled for 6 times to obtain final mix compound of sidewall rubber with hydrotalcite added, ie. the composite materials of tire sidewall rubber.

### Example 4

According to the ratio of each ingredient in table 3, the rotational speed of internal mixer was set to 85 rpm, and the initial temperature of the internal mixer was 60° C. The natural rubber and the butadiene rubber were plasticated in an internal mixer for 45 seconds, then organically modified Mg—Al hydrotalcite powder (7 parts by weight), the carbon black N330, the treated distillate aromatic extract (TDAE), zinc oxide, stearic acid, para-4-tert-butyl phenol formaldehyde resin 0411, antiager 6PPD, antiager RD and microcrystalline wax were added to the internal mixer to mix. When the temperature of the internal mixer was up to 122° C., lift a ram piston for 9 seconds, and then press the ram piston. When the temperature of the internal mixer was 160° C., the rubber was discharged to obtain a section of rubber mix compound. After the section of rubber mix compound being cooled at room temperature for 8 hours, the sulfur powder and the accelerator TBBS were added to twin-roll open mill to mix until all components dispersed into the rubber. The rubber mix compound was rolled for 5 times, then the roll spacing was set to 2 mm, and the rubber mix compound was milled for 7 times to obtain final mix compound of sidewall rubber with hydrotalcite added, ie. the composite materials of tire sidewall rubber.

### Example 5

According to the ratio of each ingredient in table 3, the rotational speed of internal mixer was set to 95 rpm, and the initial temperature of the internal mixer was 60° C. The natural rubber and the butadiene rubber were plasticated in an internal mixer for 30 seconds, then organically modified. Mg—Al hydrotalcite powder (10 parts by weight), the carbon black N330, the treated distillate aromatic extract (TDAE), zinc oxide, stearic acid, para-4-tert-butyl phenol formaldehyde resin, antiager 6PPD, antiager RD and microcrystalline wax were added to the internal mixer to mix. When the temperature of the internal mixer was up to 123° C., lift a ram piston for 6 seconds, and then press the ram piston. When the temperature of the internal mixer was 155° C., the rubber was discharged to obtain a section of rubber mix compound. After the section of rubber mix compound being cooled at room temperature for 8 hours, the sulfur powder and the accelerator TBBS were added to twin-roll open mill to mix until all components dispersed into the rubber. The rubber mix compound was rolled for 4 times, then the roll spacing was set to 2 mm, and the rubber mix compound was milled for 6 times to obtain final mix compound of sidewall rubber with hydrotalcite added, ie. the composite materials of tire sidewall rubber.

### Example 6

According to the ratio of each ingredient in table 3, the rotational speed of internal mixer was set to 80 rpm, and the initial temperature of the internal mixer was 60° C. The natural rubber and the butadiene rubber were plasticated in an internal mixer for 40 seconds, then organically modified Mg—Zn—Al hydrotalcite powder (5 parts by weight), the carbon black N330, the treated distillate aromatic extract (TDAE), zinc oxide, stearic acid, para-4-tert-butyl phenol formaldehyde resin 0411, antiager 6PPD, antiager RD and microcrystalline wax were added to the internal mixer to mix. When the temperature of the internal mixer was up to 125° C., lift a ram piston for 10 seconds, and then press the ram piston. When the temperature of the internal mixer was 155° C., the rubber was discharged to obtain a section of rubber mix compound. After the section of rubber mix compound being cooled at room temperature for 8 hours, the sulfur powder and the accelerator TBBS were added to twin-roll open mill to mix until all components dispersed into the rubber. The rubber mix compound was rolled for 5 times, then the roll spacing was set to 2 mm, and the rubber mix compound was milled for 5 times to obtain final mix compound of sidewall rubber with hydrotalcite added, ie. the composite materials of tire sidewall rubber.

### Example 7

According to the ratio of each ingredient in table 3, the rotational speed of internal mixer was set to 80 rpm, and the initial temperature of the internal mixer was 60° C. The natural rubber and the butadiene rubber were plasticated in an internal mixer for 20 seconds, then unmodified Mg—Al hydrotalcite powder (5 parts by weight), the carbon black N330, the treated distillate aromatic extract (TDAE), zinc oxide, stearic acid, para-4-tert-butyl phenol formaldehyde resin 0411, antiager 6PPD, antiager RD and microcrystalline wax were added to the internal mixer to mix. When the temperature of the internal mixer was up to 125° C., lift a ram piston for 10 seconds, and then press the ram piston. When the temperature of the internal mixer was 155° C., the rubber was discharged to obtain a section of rubber mix compound. After the section of rubber mix compound being cooled at room temperature for 8 hours, the sulfur powder and the accelerator TBBS were added to twin-roll open mill to mix until all components dispersed into the rubber. The rubber mix compound was rolled for 5 times, then the roll spacing was set to 2 mm, and the rubber mix compound was milled for 5 times to obtain final mix compound of sidewall rubber with hydrotalcite added, ie. the composite materials of tire sidewall rubber.

### Comparative Example 1

According to the ratio of each ingredient in table 3, the rotational speed of internal mixer was set to 80 rpm, and the initial temperature of the internal mixer was 60° C. The natural rubber and the butadiene rubber were plasticated in an internal mixer for 40 seconds, then the carbon black N330, the treated distillate aromatic extract (TDAE), zinc oxide, stearic acid, para-4-tert-butyl phenol formaldehyde resin 0411, antiager 6PPD, antiager RD and microcrystalline wax were added to the internal mixer to mix. When the temperature of the internal mixer was up to 125° C., lift a ram piston for 10 seconds, and then press the ram piston. When the temperature of the internal mixer was 155° C., the rubber was discharged to obtain a section of rubber mix compound. After the section of rubber mix compound being cooled at room temperature for 8 hours, the sulfur powder and the accelerator TBBS were added to twin-roll open mill to mix until all components dispersed into the rubber. The rubber mix compound was rolled for 5 times, then the roll spacing was set to 2 mm, and the rubber mix compound was milled for 5 times to obtain final mix compound of sidewall rubber without any hydrotalcite added, ie. the composite materials of tire sidewall rubber without hydrotalcite added.

### Comparative Example 2

According to the ratio of each ingredient in table 3, the rotational speed of internal mixer was set to 80 rpm, and the initial temperature of the internal mixer was 60° C. The natural rubber and the butadiene rubber were plasticated in an internal mixer for 40 seconds, then organically modified Mg—Al hydrotalcite powder (5 parts by weight), the carbon black N330, the treated distillate aromatic extract (TDAE), zinc oxide, stearic acid, para-4-tert-butyl phenol formaldehyde resin 0411 and microcrystalline wax were added to the internal mixer to mix. When the temperature of the internal mixer was up to 125° C., lift a ram piston for 10 seconds, and then press the ram piston. When the temperature of the internal mixer was 155° C., the rubber was discharged to obtain a section of rubber mix compound. After the section of rubber mix compound being cooled at room temperature for 8 hours, the sulfur powder and the accelerator TBBS were added to twin-roll open mill to mix until all components dispersed into the rubber. The rubber mix compound was rolled for 5 times, then the roll spacing was set to 2 mm, and the rubber mix compound was milled for 5 times to obtain final mix compound of sidewall rubber with hydrotalcite added but without antiager added, ie. the hydrotalcite composite materials of tire sidewall rubber without antiager added.

TABLE 3
The amount of components of Examples 1-7 and Comparative Examples 1-2 (unit: parts by weight)

| | Example | Example | Example | Example | Example | Example | Example | Comparative | Comparative |
|---|---|---|---|---|---|---|---|---|---|
| | 1 | 2 | 3 | 4 | 5 | 6 | 7 | Example 1 | Example 2 |
| natural rubber | 60 | 60 | 60 | 60 | 60 | 60 | 60 | 60 | 60 |
| butadiene rubber | 40 | 40 | 40 | 40 | 40 | 40 | 40 | 40 | 40 |
| modified Mg-Al | 1 | 3 | 5 | 7 | 10 | 0 | 0 | 0 | 5 |
| hydrotalcite | | | | | | | | | |
| powder | | | | | | | | | |
| modified | 0 | 0 | 0 | 0 | 0 | 5 | 0 | 0 | 0 |
| Mg-Zn-Al | | | | | | | | | |
| hydrotalcite | | | | | | | | | |
| powder | | | | | | | | | |
| unmodified | 0 | 0 | 0 | 0 | 0 | 0 | 5 | 0 | 0 |
| Mg-Al | | | | | | | | | |
| hydrotalcite | | | | | | | | | |
| powder | | | | | | | | | |
| carbon black | 55 | 55 | 55 | 55 | 55 | 55 | 55 | 55 | 55 |
| N330 | | | | | | | | | |
| the treated | 5 | 5 | 5 | 5 | 5 | 5 | 5 | 5 | 5 |
| distillate | | | | | | | | | |
| aromatic extract | | | | | | | | | |
| TDAE | | | | | | | | | |
| 6PPD | 3 | 3 | 3 | 3 | 3 | 3 | 3 | 3 | 0 |
| RD | 1 | 1 | 1 | 1 | 1 | 1 | 1 | 1 | 0 |
| microcrystalline | 1.5 | 1.5 | 1.5 | 1.5 | 1.5 | 1.5 | 1.5 | 1.5 | 1.5 |
| wax 654 | | | | | | | | | |
| tackifying resin | 1 | 1 | 1 | 1 | 1 | 1 | 1 | 1 | 1 |
| 0411 | | | | | | | | | |
| zinc oxide | 4 | 4 | 4 | 4 | 4 | 4 | 4 | 4 | 4 |
| stearic acid | 2 | 2 | 2 | 2 | 2 | 2 | 2 | 2 | 2 |
| Oil-filled sulfur | 1.5 | 1.5 | 1.5 | 1.5 | 1.5 | 1.5 | 1.5 | 1.5 | 1.5 |
| powder | | | | | | | | | |
| Accelerator | 1 | 1 | 1 | 1 | 1 | 1 | 1 | 1 | 1 |
| TBBS | | | | | | | | | |
| hydrotalcite/antiager | 0.25 | 0.75 | 1.25 | 1.75 | 2.5 | 1.25 | 1.25 | 0 | / |

The composite materials of tire sidewall rubber obtained by examples 1-7 and comparative examples 1-2 were vulcanized for 30 minutes at 151° C. Then, the basic methanical properties of the rubber were tested, and the test results were shown in table 4.

Wherein, assay method of Shore A hardness was as follows: according to the method of GB/T531-1999, Shore A hardness was measured by Shore A hardness meter, and the formula is:

F=550+75H_{A}

Wherein F refers to the force applied on the needle, mN;

H_{A} refers to the indicating value of Shore A hardness meter.

Assay method of tensile strength was as follows: the tensile strength of samples of examples and comparative examples was tested according to the method of GB/T528-1998. When measuring the tensile strength, Itype dumbbell-shaped specimens were used, and electronic tensile tester was used to test the dumbbell-shaped specimens. The length and force change of test was continuously monitored, and it was calculated according to the following formula:

TS=F_{W}/Wt

Wherein, TS refers to the tensile strength, MPa; F_{W} refers to the maximum force recorded, N; W refers to the width of narrow parallel portion of cut-off knife, mm; t refers to the thickness of length portion of test, mm.

Assay method of elongation at break was as follows: the elongation at break of samples of examples and comparative examples was measured according to the method of GB/T528-1998, and it was calculated according to the following formula:

$${E}_{b} = \frac{100 ( {L}_{b} - {L}_{0} )}{{L}_{0}}$$

Wherein, E_{b} refers to the elongation at break,%; L_{b} refers to gauge length at the time of specimen fracture, mm; L₀ refers to original gauge length of the specimen, mm.

Assay method of tear strength was as follows: the tear strength of samples in examples and comparative examples was measured according to the method of GB/T529-2008. The crescent cut samples were continuously stretched by using the tensile testing machine (model: XL-250A, producer: Guangzhou Guangcai Experimental Instrument Co., Ltd.), until the samples were teared, and the tear strength of the samples were tested. The higher reported value means the better tearing performance.

Assay method of 25° C. rebound was as follows: the resilience of samples in examples and comparative examples was measured according to the method of GB/T1681-1991. 25° C. rebound was calculated according to the formula:

R=k/H×100%

Wherein, R refers to rebound values, %.

k refers to rebound height, mm.

H refers to drop height, mm.

TABLE 4
physical property test results of samples in examples 1-7 and comparative examples 1-2

| | Basic physical | Example | Example | Example | Example | Example | Example | Example | comparative | comparative |
|---|---|---|---|---|---|---|---|---|---|---|
| | property | 1 | 2 | 3 | 4 | 5 | 6 | 7 | example 1 | example 2 |
| Before | Shore A | 51 | 52 | 53 | 53 | 54 | 52 | 53 | 51 | 50 |
| aging | hardness | | | | | | | | | |
| | tensile strength/ | 19.2 | 18.9 | 17.9 | 17.6 | 17.1 | 17.8 | 18.9 | 19.5 | 18.1 |
| | MPa | | | | | | | | | |
| | elongation at | 712 | 728 | 734 | 738 | 740 | 735 | 729 | 710 | 730 |
| | break/% | | | | | | | | | |
| | tear strength/ | 73 | 70 | 72 | 66 | 62 | 72 | 74 | 72 | 72 |
| | KN/m | | | | | | | | | |
| | 25° C. rebound/ | 57 | 54 | 55 | 54 | 51 | 55 | 54 | 55 | 47 |
| | % | | | | | | | | | |
| After | Shore A | 57 | 58 | 59 | 59 | 60 | 58 | 59 | 57 | 59 |
| aging | hardness | | | | | | | | | |
| | tensile strength/ | 16.3 | 16.7 | 17 | 16.5 | 15 | 17.2 | 16.7 | 15.5 | 14.2 |
| | MPa | | | | | | | | | |
| | elongation at | 540 | 532 | 550 | 525 | 503 | 551 | 535 | 510 | 489 |
| | break/% | | | | | | | | | |
| | tear strength/ | 42 | 44 | 42 | 43 | 38 | 44 | 43 | 40 | 38 |
| | KN/m | | | | | | | | | |
| | 25° C. rebound/ | 58 | 56 | 57 | 57 | 54 | 56 | 57 | 58 | 50 |
| | % | | | | | | | | | |

It can be seen from table 4 that, compared with the comparative example 1, with the increase of the amount of the organically modified Mg—Al hydrotalcite powder, the tensile strength and the tear strength of the rubber in examples 1˜5 showed a downward trend, both the hardness and the elongation at break showed increasing trend. 5 parts by weight of organically modified Mg—Al—Zn hydrotalcite powder and unmodified Mg—Al hydrotalcite powder were respectively added in example 6 and example 7, the hardness, the tear strength and elongation at break of the rubber were increased, and the tensile strength was reduced to some extent.

Chang rate of aging of the rubber physical properties=(physical properties after aging−physical properties before aging)/physical properties before aging. By comparing the change rate of basic physical properties of the rubber before and after aging, the thermo-oxidative aging resistance properties of the rubber was studied. The lower the change rate of aging (ie, absolute value) of the rubber, the better the thermo-oxidative aging resistance properties of the rubber. The change rate of aging was obtained by calculating the data of the rubber before and after aging from table 4, and the results were shown in table 5.

TABLE 5
the change rate of aging of each physical property of samples in examples 1-7 and comparative examples 1-2

| | Basic | | | | | | | | | |
|---|---|---|---|---|---|---|---|---|---|---|
| | physical | Example | Example | Example | Example | Example | Example | Example | Comparative | Comparative |
| | properties | 1 | 2 | 3 | 4 | 5 | 6 | 7 | example 1 | example 2 |
| The | Shore | 11.8% | 11.5% | 11.3% | 11.3% | 11.1% | 11.5% | 11.3% | 11.8% | 18.0% |
| change | A | | | | | | | | | |
| rate of | hardness | | | | | | | | | |
| aging | tensile | −15.1% | −11.6% | −5.0% | −6.3% | −12.3% | −3.4% | −11.6% | −20.5% | −21.5% |
| | strength | | | | | | | | | |
| | extension | −24.2% | −26.9% | −25.1% | −30.9% | −32.0% | −25.0% | −26.6% | −28.2% | −33.0% |
| | at break | | | | | | | | | |
| | tear | −42.5% | −37.1% | −41.7% | −34.8% | −38.7% | −38.9% | −41.9% | −44.4% | −47.2% |
| | strength | | | | | | | | | |
| | 25° C. | 1.8% | 3.7% | 3.6% | 5.6% | 5.9% | 1.8% | 5.6% | 5.5% | 6.4% |
| | rebound | | | | | | | | | |

It can be seen from the date of table 5 that: compared with the change rate of aging of each physical properties of the rubber of the comparative example 1 without adding hydrotalcite powder, after adding different amounts of hydrotalcite dry powder in Examples 1-7, the change rate of aging of each physical properties of the rubber is relatively lower overall, that is, the addition of hydrotalcite powder can improve the thenno-oxidative aging resistance properties of the rubber.

Compared with the change rate of aging of each physical properties of the rubber of the comparative example 2 with adding 5 parts by weight of hydrotalcite and without adding antiager, the change rate of aging of each basic physical property of the rubber of example 3, example 6 and example with adding 5 parts by weight of hydrotalcite powder is relatively lower. Therefore, the antiager in the rubber plays an important role in improving the thermo-oxidative aging resistance properties of the rubber.

To further verify the thermo-oxidative aging resistance properties of the rubber, it is characterized by tensile product aging coefficient commonly used in rubber, and the formula is as follows:

tensile product aging coefficient=(tensile strength×extension at break) after aging/(tensile strength×extension at break) before aging

The tensile product aging coefficient of the rubber of comparative examples 1-2 and examples 1-7 was obtained by calculating the data of table 4, and were shown in table 6. When the aging coefficient is <1, the higher the value, the better the aging resistance of the rubber.

TABLE 6
the tensile product aging coefficient of the rubber of comparative examples 1−2 and examples 1-7

| | Example | Example | Example | Example | Example | Example | Example | Comparative | Comparative |
|---|---|---|---|---|---|---|---|---|---|
| | 1 | 2 | 3 | 4 | 5 | 6 | 7 | example 1 | example 2 |
| tensile | 0.644 | 0.646 | 0.712 | 0.667 | 0.596 | 0.724 | 0.648 | 0.571 | 0.526 |
| product | | | | | | | | | |
| aging | | | | | | | | | |
| coefficient | | | | | | | | | |

It can be seen from the date of table 5 that: compared with the comparative example 1, with the increase of the loading amount of the organically modified magnesium aluminum hydrotalcite powder, the tensile product aging coefficient of the rubber showed a trend of increasing first and then decreasing. Wherein, the rubber filled with 5 parts by weight of modified magnesium aluminum hydrotalcite powder of example 3 had the best thermo-oxidative aging resistance;

It can be seen that, comparing the tensile product aging coefficient of example 3 with that of example 6 and example 7, under the condition of adding 5 parts by weight of the same mass parts of hydrotalcite, the rubber of example 6 with adding of organically modified magnesium aluminum zinc hydrotalcite powder had the best thermo-oxidative aging resistance, followed by the the rubber of example 3 with adding the organically modified magnesium aluminum hydrotalcite powder, and finally the rubber of example 7 with adding the unmodified hydrotalcite powder. However, compared with the rubber of comparative Example 1, the thermo-oxidative aging resistance of the three groups of rubbers with adding different structural hydrotalcites was significantly improved.

In addition to the thermo-oxidative aging resistance, the present invention further studied anti-ultraviolet aging performance of the rubber. The test condition is as follows: the rubber was irradiated with high power UV lamp, and the UV irradiation power is 1000 w/m². Temperature is 70° C. and irradiation time is 260 min. The cracks on the surface of the rubber were visually compared. The surface cracks of the rubber in comparative example 1 were dense and the cracks were deeper. The surface of the rubber in example 1, example 2, example 4, example 5 and example 7 all had different degrees of cracks. But compared with the comparative example 1, the surface of the rubber had less cracks. The surface of the rubber in example 3 and example 7 showed no obvious cracks, demonstrated that the anti-ultraviolet aging performance of the sidewall rubber can be effectively improved by adding hydrotalcite. Wherein, the anti-ultraviolet aging performance of the rubber sample of example 3 and example 7 filled with 5 parts by weight of modified hydrotalcite was best.

The above are only preferred embodiments of the present invention, and are not intended to limit the scope of the present invention. Any modifications, equivalent substitutions, and improvements made within the spirit and principles of the present invention need to be included within the protection scope of the present invention.

We claim:

1. A composite materials of tire sidewall rubber, characterized in that, the composite materials comprise 100 parts by weight of rubber, the materials further comprise 1˜10 parts by weight of hydrotalcite, 40˜70 parts by weight of carbon black, 4.0˜8.0 parts by weight of treated distillate aromatic extract, 3.0˜9.0 parts by weight of antiager, 1.0˜4.0 parts by weight of wax, 0.5˜3.0 parts by weight of tackifying resin, 1.5˜5.0 parts by weight of zinc oxide, 1.0˜3.5 parts by weight of stearic acid, 1.0˜3.0 parts by weight of sulfur powder, and 0.5˜2.0 parts by weight of accelerator.

2. The composite materials according to claim 1, characterized in that, the weight ratio of the hydrotalcite to the antiager in the composite materials is 0.25˜2.5, preferably 0.75˜1.75.

3. The composite materials according to claim 1, characterized in that, the antiager is one or two or more selected from the group consisting of
N-(1,3-dimethylbutyl)-N′-phenyl-p-phenylenediamine,
2,2,4-trimethyl-1,2-dihydroquinoline polymer,
N,N′-xylyl-p-phenylenediamine,2-mercaptobenzimidazol zinc salt,
9,9-dimethylacridan, N,N′-phenyl-p-phenylenediamine and
6-ethoxyl-2,2,4-trimethyl-1,2-dihydrquinoline.

4. The composite materials according to claim 2, characterized in that, the antiager is one or two or more selected from the group consisting of
N-(1,3-dimethylbutyl)-N′-phenyl-p-phenylenediamine,
2,2,4-trimethyl-1,2-dihydroquinoline polymer,
N,N′-xylyl-p-phenylenediamine,2-mercaptobenzimidazol zinc salt,
9,9-dimethylacridan, N,N′-phenyl-p-phenylenediamine and
6-ethoxyl-2,2,4-trimethyl-1,2-dihydrquinoline.

5. The composite materials according to claim 1, characterized in that, the rubber is one or two or more selected from the group consisting of natural rubber, butadiene rubber, butyronitrile rubber, styrene-butadiene rubber, isoprene rubber or ethylene-propylene rubber, the wax is one or more selected from the group consisting of micro-crystalline wax, polyethene wax, polypropylene wax or oxidized polyethlene wax.

6. The composite materials according to claim 2, characterized in that, the rubber is one or two or more selected from the group consisting of natural rubber, butadiene rubber, butyronitrile rubber, styrene-butadiene rubber, isoprene rubber or ethylene-propylene rubber, the wax is one or more selected from the group consisting of micro-crystalline wax, polyethene wax, polypropylene wax or oxidized polyethlene wax.

7. The composite materials according to claim 1, characterized in that, the rubber is one or two or more selected from the group consisting of natural rubber, butadiene rubber, butyronitrile rubber, styrene-butadiene rubber, isoprene rubber or ethylene-propylene rubber, the wax is one or more selected from the group consisting of micro-crystalline wax, polyethene wax, polypropylene wax or oxidized polyethlene wax.

8. The composite materials according to claim 5, characterized in that, the rubber comprises the natural rubber and the butadiene rubber, wherein, the natural rubber accounts for 30˜65 parts by weight, preferably 40˜60 parts by weight; the butadiene rubber accounts for 35˜70 parts by weight, preferably 40˜60 parts by weight.

9. The composite materials according to claim 1, characterized in that, the hydrotalcite is one or two or more selected from the group consisting of magnesium aluminum base hydrotalcite, magnesium zinc aluminum base hydrotalcite and organo-modified hydrotalcite, wherein, organic modifier of the hydrotalcite is preferably organic silane coupling agent types, the molecular structure characteristic of the organic silane coupling agent is one or two or more organic group selected from the group consisting of —S—S—, —Sx-, —S—H or —C═C—.

10. The composite materials according to claim 1, characterized in that, the hydrotalcite is one or two or more selected from the group consisting of magnesium aluminum base hydrotalcite, magnesium zinc aluminum base hydrotalcite and organo-modified hydrotalcite, wherein, organic modifier of the hydrotalcite is preferably organic silane coupling agent types, the molecular structure characteristic of the organic silane coupling agent is one or two or more organic group selected from the group consisting of —S—S—, —Sx-, —S—H or —C═C—.

11. The composite materials according to claim 2, characterized in that, the hydrotalcite is one or two or more selected from the group consisting of magnesium aluminum base hydrotalcite, magnesium zinc aluminum base hydrotalcite and organo-modified hydrotalcite, wherein, organic modifier of the hydrotalcite is preferably organic silane coupling agent types, the molecular structure characteristic of the organic silane coupling agent is one or two or more organic group selected from the group consisting of —S—S—, —Sx-, —S—H or —C═C—.

12. The composite materials according to claim 3, characterized in that, the hydrotalcite is one or two or more selected from the group consisting of magnesium aluminum base hydrotalcite, magnesium zinc aluminum base hydrotalcite and organo-modified hydrotalcite, wherein, organic modifier of the hydrotalcite is preferably organic silane coupling agent types, the molecular structure characteristic of the organic silane coupling agent is one or two or more organic group selected from the group consisting of —S—S—, —Sx-, —S—H or —C═C—.

13. The composite materials according to claim 5, characterized in that, the hydrotalcite is one or two or more selected from the group consisting of magnesium aluminum base hydrotalcite, magnesium zinc aluminum base hydrotalcite and organo-modified hydrotalcite, wherein, organic modifier of the hydrotalcite is preferably organic silane coupling agent types, the molecular structure characteristic of the organic silane coupling agent is one or two or more organic group selected from the group consisting of —S—S—, —Sx-, —S—H or —C═C—.

14. The composite materials according to claim 8, characterized in that, the hydrotalcite is one or two or more selected from the group consisting of magnesium aluminum base hydrotalcite, magnesium zinc aluminum base hydrotalcite and organo-modified hydrotalcite, wherein, organic modifier of the hydrotalcite is preferably organic silane coupling agent types, the molecular structure characteristic of the organic silane coupling agent is one or two or more organic group selected from the group consisting of —S—S—, —Sx-, —S—H or —C═C—.

15. The composite materials according to claim 9, characterized in that, the hydrotalcite is one or two or more selected from the group consisting of magnesium aluminum base hydrotalcite, magnesium zinc aluminum base hydrotalcite and organo-modified hydrotalcite, wherein, organic modifier of the hydrotalcite is preferably organic silane coupling agent types, the molecular structure characteristic of the organic silane coupling agent is one or two or more organic group selected from the group consisting of —S—S—, —Sx-, —S—H or —C═C—.

16. The composite materials according to claim 9, characterized in that, the organic silane coupling agent is one or two or more selected from the group consisting of coupling agent A-151, A-171, A-172, KH540, KH-550, KH-560, KH-570, KH-590, KH-792, Si-602, Si-69 or Si75.

17. The composite materials according to claim 1, characterized in that, the tackifying resin comprises phenolic resin, the accelerator is one or more selected from the group consisting of N-tert-butyl-2-benzothiazolesulfenamide, zinc(ii) dibutyl dithiocarbamate or dipentamethylene thiuram hexasulfide, the carbon black comprises N series of carbon black, and the sulfur powder comprises oil extended sulfur powder.

18. The composite materials according to claim 2, characterized in that, the tackifying resin comprises phenolic resin, the accelerator is one or more selected from the group consisting of N-tert-butyl-2-benzothiazolesulfenamide, zinc(ii) dibutyl dithiocarbamate or dipentamethylene thiuram hexasulfide, the carbon black comprises N series of carbon black, and the sulfur powder comprises oil extended sulfur powder.

19. A preparation method of the composite materials of claim 1, characterized in that, the preparation method comprises the following steps of:
(1) plasticating rubber in an internal mixer;
(2) adding the hydrotalcite, the carbon black, the treated distillate aromatic extract, the zinc oxide, the stearic acid, the tackifying resin, the antiager and the wax to carry out mixing;
(3) lifting ram piston when the temperature of the internal mixer is up to 120˜125° C., then depressing the ram piston;
(4) discharging rubber when the temperature of the internal mixer is up to 150˜160° C. to obtain rubber mix compound;
(5) cooling the rubber mix compound obtained by step (4), placing the rubber compound into open mill, then adding the sulfur powder and the accelerator, mixing and rolling; and
(6) milling to obtain composite materials of tire sidewall rubber.

20. The preparation method according to claim 19, characterized in that, the time of plasticating rubber in the internal mixer of step (1) is 20˜50 seconds, the speed of the internal mixer is 80˜100 rpm.
